(19) United States
(12) Patent Application Publication
(10) Pub. No.: US 2014/0214863 A1
(43) Pub. Date: Jul. 31, 2014

(54) SELECTING DATA ITEMS FOR DISPLAY THAT ARE ASSOCIATED WITH ENTITIES THAT HAVE REPRESENTATIONS PLACED IN A SELECTED STATE

(71) Applicant: HEWLETT-PACKARD DEVELOPMENT COMPANY, L.P., Houston, TX (US)

(72) Inventors: Benjamin Andrew Rottler, San Francisco, CA (US); Gregory Robert Arroyo, San Francisco, CA (US)

(73) Assignee: Hewlett-Packard Development Company, L.P., Houston, TX (US)

(21) Appl. No.: 13/756,214

(22) Filed: Jan. 31, 2013

(51) Int. Cl. G06F 17/30

(52) U.S. Cl. CPC G06F 17/3089
USPC 707/754

(57) ABSTRACT

A plurality of entities are each associated with a corresponding set of data items. A representation is assigned to each entity in the plurality of entities. The representation of any one or more entities in the plurality of entities can be placed in a selected state with user input. Data items from the collection can be filtered based on the representations that are placed in the selected state.

### BACKGROUND

Managing content and data items is increasingly social. Users can now share messages, images, and documents through a plethora of online sources and applications.

### BRIEF DESCRIPTION OF THE DRAWINGS

FIG. 1 is an example system for displaying data items that are associated with entities.

FIG. 2A is an example method for displaying data items that are associated with entities.

FIG. 2B is an example method for filtering data items from a collection based on filtering parameters associated with specific entities.

FIG. 3A through FIG. 3F illustrate various example interfaces for displaying data items from a collection based on a selected entity or set of entities.

FIG. 4 illustrates an example hardware diagram for a computer system upon which examples described herein can be implemented.

### DETAILED DESCRIPTION

Examples described herein enable users to filter data items based on selection of entities, such as friends or contacts. With selection of one or multiple entities, data items can be filtered for purpose of presenting content originating from, or related to the select entities.

In one example, each entity in a plurality of entities is associated with a corresponding set of data items. A representation is assigned to each entity in the plurality of entities. The representation of any one or more entities in the plurality of entities can be placed in a selected state with user input. Based on the selection of the entity, data items are selected for display.

In a variation, a system includes a memory and a processor. The memory stores a collection of data items. The processor associates each entity in a plurality of entities with a filter parameter. A representation is provided of each entity. A user can select the representation of any one or more entities with input. The collection can be filtered based on a filter parameter associated with the entity represented by each representation that is placed in the selected state

Still further, an example includes a computing device having a memory and a processor. The memory stores a collection of data items. The processor associates each entity in a plurality of entities with a corresponding set of data items. A graphic representation is assigned to each entity in the plurality of entities, and the graphic representation of any one or more entities can be placed in a selected state. A selection is made of data items from the set of data items of each entity for which the assigned representation is placed in the selected state. The data items can be displayed in at least a portion of a display area for displaying items from the collection of items.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network-enabled resources (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

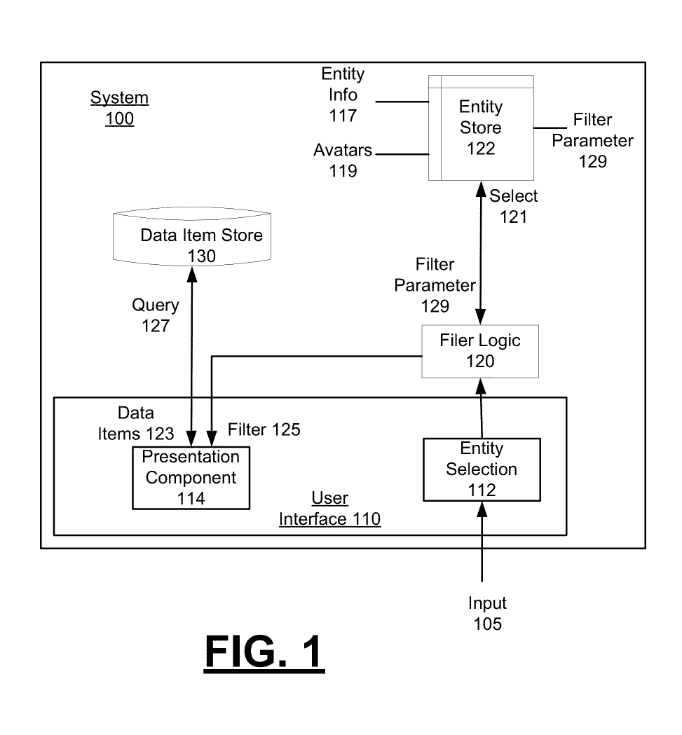

FIG. 1 is an example system for displaying data items that are associated with entities. A system 100 can be implemented in a variety of computing environments. For example, system 100 can be implemented on a server, or combination of servers, and provide a network service for computing devices operated by users of the service. In such an implementation, the service can be provided over the Internet, and accessible through, for example, browsers. The functionality described with an example of FIG. 1 can further be provided in context of an existing network service. In a variation, a service such as described with an example of FIG. 1 can be implemented with a service that has an alternative primary functionality, such as online photo storage or sharing service, a social networking site, a note sharing service, and/or online document archiving.

As an alternative, system 100 can be implemented on a computing device, such as on a personal computer, tablet or mobile computing device. In such an implementation, system 100 can operate as, for example, an application or application layer logic. Moreover, system 100 can operate with resources of other applications, such as contact databases, document folders, photo-viewers, and messaging applications. Accordingly, system 100 can be implemented using application layer logic, such as in the form of an application or combination of applications. Still further, system 100 can be implemented as an application or plug-in that cooperates with other existing resources or applications of a computing device to provide functionality that includes filtering a collection of data items.

With further reference to FIG. 1, system 100 includes a user interface 110 and filter logic 120. The system 100 may also include, or cooperate with data stores, including an entity store 122 and a data item store 130. The user interface 110 can include an entity selection component 112 and a presentation component 114. The entity store 122 can retain information 117 corresponding to multiple entities (“entity information 117”), including individuals, groups or organizations. In one example, entities can correspond to contacts (e.g., persons identified in information records that are stored on the computing device or with an account of the user) of a user associated with system 100. In one implementation, the entity store 122 can retain entity information 117, such as the name of a person, as well as contact information or other identifiers that can serve to distinguish the entity from other entities. As described further, the identifier of the individual entities can be associated with a filter parameter 129. In this way, the filter parameter 129 can serve to sort or otherwise filter data items that originate with, or are communicated by, a corresponding entity.

As an alternative or addition, the entity store 122 can also include avatar input 119. The avatar input 119 can associate an image (e.g., anime, icon, photograph etc.) with a specific entity as identified by the entity information 117. In one implementation, the entity store 122 correlates individual entities with corresponding filter parameters 129.

The data item store 130 can correspond to one or more data stores or other memory resources that retain data items of the user associated with system 100. Examples of data items include files, documents, and records. More specific examples of data items can include (i) images (e.g., images uploaded are communicated by a contact of the user), (ii) documents that are edited or authored by particular entity, (iii) social networking posts or online commentary (e.g., TWEETS), and/or (iv) messaging records, such as e-mails. In one implementation, the data store 130 maintains multiple types of data items for use with filtering examples as described herein.

In one implementation, the user of system 100 interacts with user interface 110 to specify an input 105 that is made through entity selection 112 and which corresponds to the selection of a particular entity. For example, the entity selection 112 can correspond to a graphic panel or other user-interface feature that displays avatars corresponding to entities that are identified in the entity store 122. The avatars can be based on the avatar input 119. The input 105 can be processed by entity selection 112 and communicated to the entity store 122 to determine the corresponding filter parameter 129 for the selected entity.

The filter logic 120 can process the filter parameter 129 and signal a filter 125 for the presentation component 114. As described with some examples, the filter logic 120 can operate to combine (e.g., sum) multiple filter parameters 129 in determining the filter 125 based on the selected entities. Furthermore, the filter logic 120 can adjust the filter 125 responsive to input 125, based on more or fewer filter parameters 119, as specified in the user input 105.

In one implementation, the presentation component 114 uses the filter 125 to sort, filter or otherwise organize the presentation of data items retrieved from the data item store 130. The presentation component 114 can query 127 the data item store 130 for a collection of data items 123. The filter 125 can be used to filter, sort or otherwise prioritize the collection 123 of data items. In particular, filter logic 120 can base the filter 125 on filter parameters 129 that are associated with each selected entity, as specified by the user input 105. The presentation component 114 can use the filter 125 to filter the collection of data items 123, so as to exclude data items from nonselective entities.

Various filtering mechanisms can be employed in accordance with examples described herein. In one implementation, the data items of selected entities are displayed in a given region at the exclusion of display items of non-selected entities. In another implementation, the data items of selected entities are sorted or otherwise organized to be prioritized over data items of nonselective entities. When implemented as a service, presentation component 114 can provide a process in which an output corresponds to a webpage that displays data items from the collection in filtered form, based on the data items of entities as selected by the user. Likewise, when implemented as software operating on a device, the presentation component 114 can configure a rendering of the collection 123 to filter (e.g. sort organize etc.) the data items based on the filter 125, as determined by the selected entities.

In an example of FIG. 1, the data items that are provided through the presentation component 114 can include, for example, files, folders, documents, and/or records. In some implementations, the data items that are provided through the presentation component 114 are heterogeneous. For example, many kinds of data items (e.g., images, documents, emails) can be clustered by entity and displayed (or partially rendered) as a result of a filtering operation, as described herein.

Methodology

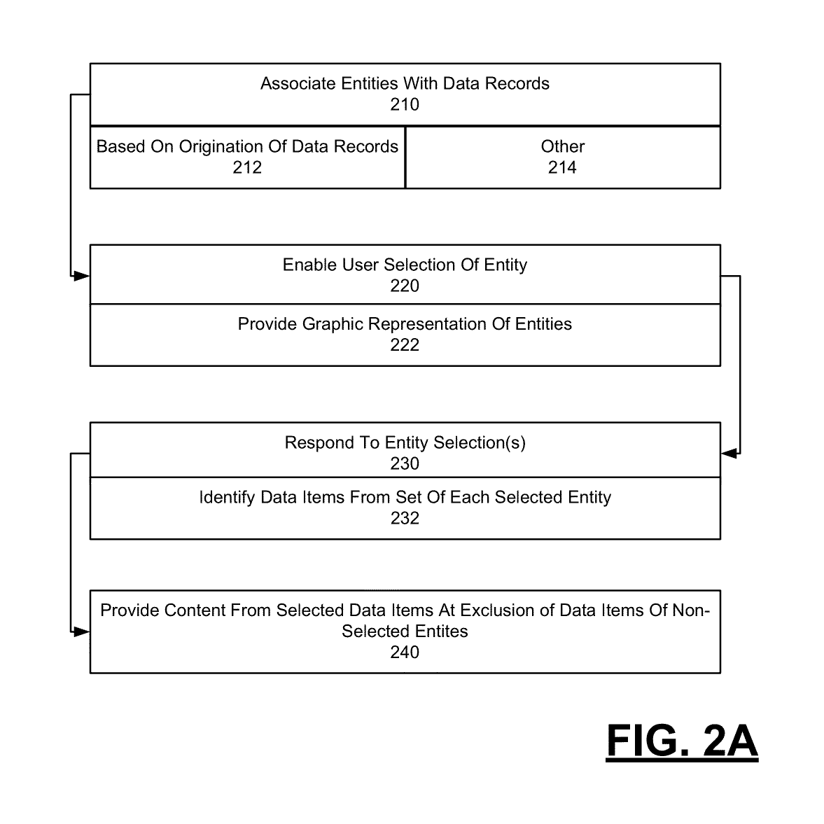

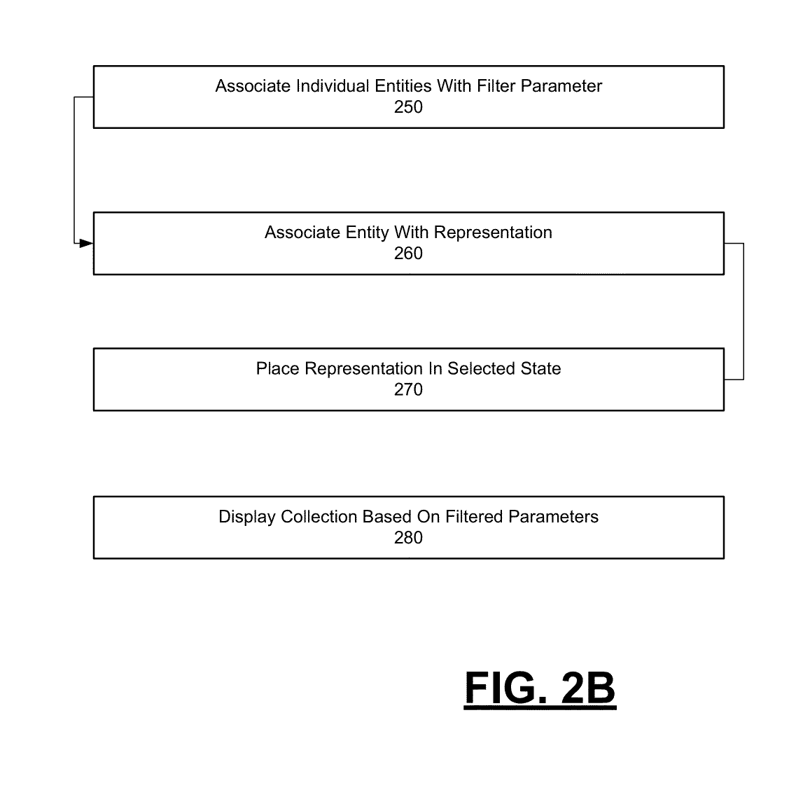

FIG. 2A is an example method for displaying data items that are associated with entities. FIG. 2B is an example method for filtering data items from a collection based on filtering parameters associated with specific entities. Example methods such as described by FIG. 2A and FIG. 2B can be implemented using components such as described with the system of FIG. 1. Accordingly, reference may be made to components of system 100 for purpose of illustrating suitable components or elements for performing a step or sub step being described.

With reference to FIG. 2A, entities are associated with data records (210). The data records can correspond to, for example, e-mails (or other communications such as instant messages, etc.), documents, images, files, or folders. The association can be, for example, in the form of metadata that links a contact or entity identifier (e.g., as identified by entity information 117 in entity store 122) with a corresponding data item or set of data items. Furthermore, the data items can reside locally and/or remotely from a location where the association is made. For example, an entity can be linked to a set of data items on a network service, or alternatively a user may link the entity with the set of data items on the machine, when the machine accesses a network service where the data records reside.

In one implementation, the association between entities and data items can be based on the origination of the data item (212). For example, system 100 can be implemented as a network service that provides a user of system 100 with an account. The user can aggregate various data items from different sources into the account. For example, the account can correspond to an online image library, and the user can aggregate images from various sources (e.g., shared images from other accounts, social networking sites, uploads etc.). In such an example, the association between the entities and corresponding data items can be based on, for example, the entities being a source of the data item when communicated or provided to the particular user (e.g., entity shares image with user, or entity e-mails user with image etc.). In such implementation, entities can be associated with a set of data items based on the entity having originated the data item (212). Moreover, the origination of the data item can be relative to a given user. For example, the origination of the data item can be specific to the user, and correspond to the entity that previously provided or communicated the data item to the specific user.

Various alternative basis can be used to associate entities with data items (214). For example, in the context of images, an entity can be associated with a set of data items based on the presence of that entity in image. For example image recognition can be performed to identify a contact within image, and once identified, the association between that contact and the image can be made.

As an alternative or addition, the association between entity and data item can be made based on metadata associated with the data item, such as metadata that identifies the user that created the data item, or metadata that identifies the user that last updated the data item.

In the context of messages such as e-mails, entities can be associated with data items based on the entity that is, for example, a sender of a message, the recipient of a message, or a copied recipient of a message. Still further, data items can be associated with entities based on the entity being identified in the body of a message, or the entity being deemed relevant to the data item based on contextual information.

The user can be enabled to make selection of a particular entity (220). In some examples, entities can be selected through user input in order to enable the user to filter data items. In particular, the data items can be filtered based on the pre-association of the selected entities and the respective data items. In one example, the user can perform the act of selection using text entry, menu selection or other forms of input in order to select contacts or other entities.

In one implementation, entities can be displayed by way of graphic representations (222). For example, in one implementation, a panel or other user interface feature is provided that displays graphic representations of entities. As described with an example of FIG. 1, the graphic representations can be in the form of avatars. As an example, a panel or other user interface feature can display a series of avatars, and the avatars can correspond to individual entities as identified by the entity store 122. As described with other examples, the avatars can represent or correspond to contacts of a user (e.g., those persons for whom corresponding contact records exist to identify phone or messaging address), as well as those individuals with whom the user frequently communicates with or exchanges data items with. For example, in the context of a webpage, a user can scroll through a list of entities, or through a series of avatars, in order to select one or more entities. In the context of a computing device such as a tablet, the user can view representations of entities (e.g., avatars) and use touch-based input to make selections of individual entities (e.g., the user can touch the individual avatars on the display screen). Numerous variations to such examples can be provided.

Input corresponding to entity selections can be recorded and used to make a selection of one or more multiple entities (230). As described in more detail, each entity can be associated with one or more filter parameters that link, or otherwise pre-associate that entity with a corresponding set of data items.

For example, in one implementation, individual entities are pre-associated with a set of data items on a given system 100. When the user selects one or more entities, data items from associated with each selected entity are identified (232).

In one implementation, content is provided from data items that are associated with selected entities (240). In particular, the provided content can represent a filtered set of data items, selected from a collection of data items. The filter can be determined based the selected entities, and the filtered data can be those that are associated with entities that are selected by the user input. In this way, content can be rendered that is based on data items associated with selected entities. This content can be rendered at the exclusion of those data items that are associated with non-selected entities.

In some implementations, the displayed content can be mixed or of different types. For example, images shared on an online service can be mixed with emails and social networking posts, and the filtering can be based on a source or originator of the various data items. Thus, for example, a user can elect a filter for a contact or set of contact, and data items corresponding to images, messages, social networking commentary etc. can be displayed for those selected contacts.

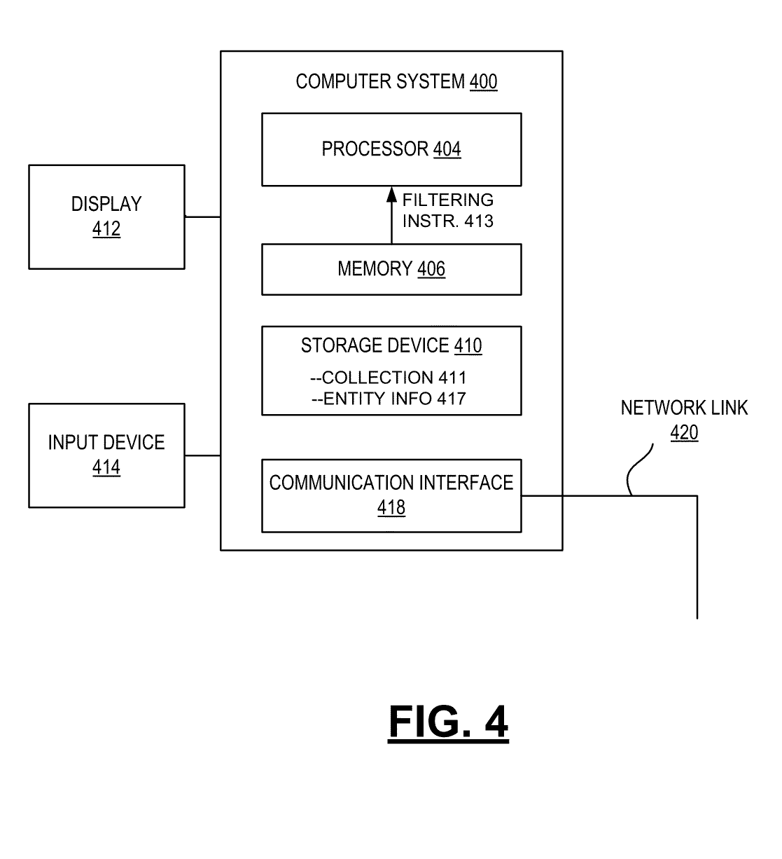

With reference to FIG. 2B, a computing system (e.g., see FIG. 4) can perform operations that include associating individual entities with a corresponding filter parameter (250). For example, a contact list can be represented as a table, and each contact can be associated with an identity or other identifier that serves as a filtering parameter.

Each entity can also be associated with a representation (260). For example, some entities may be represented by an image or a graphic. Still further, some entities may be associated with a generic, non-specific graphic (e.g., question mark).

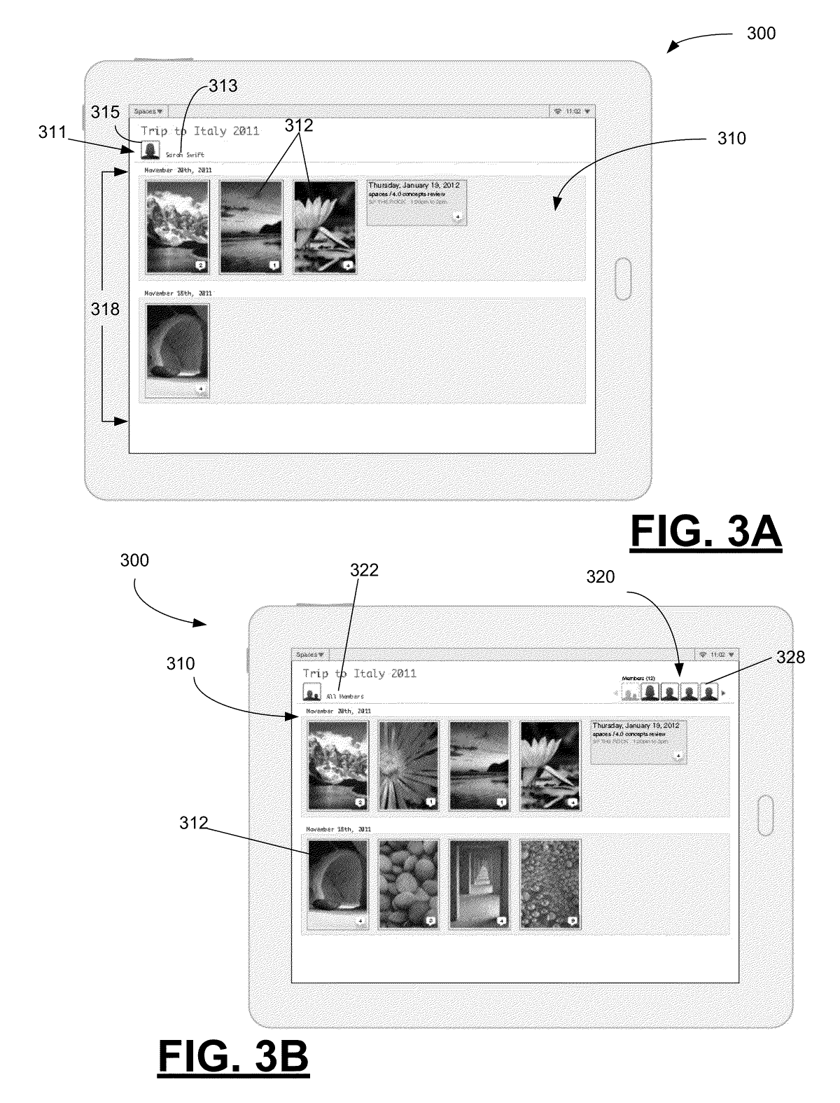

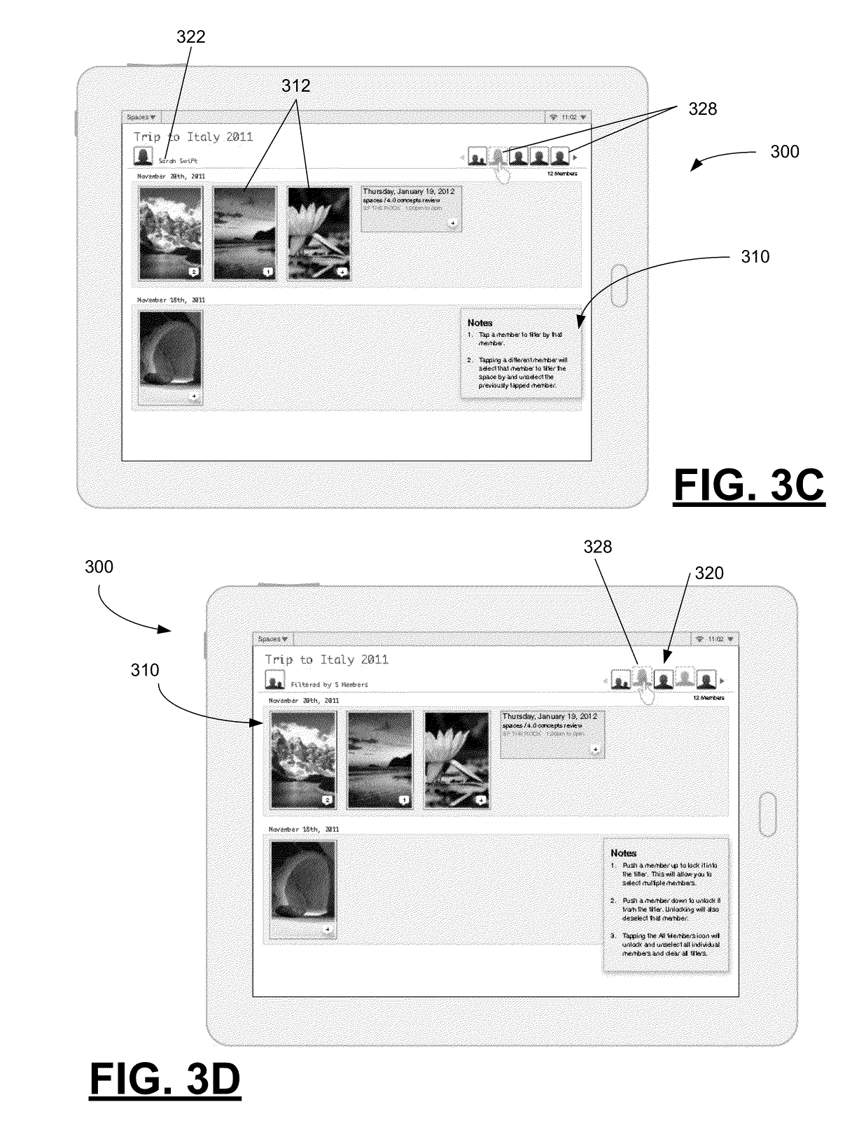

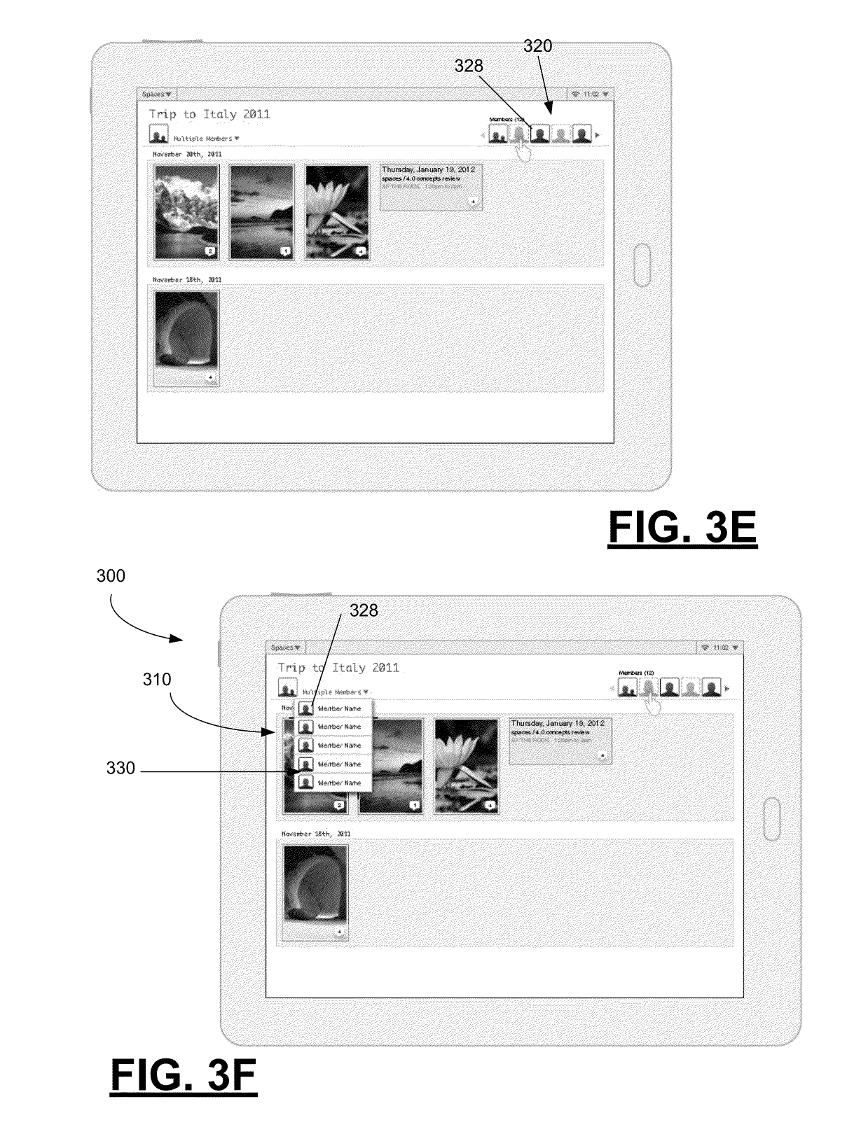

The user can operate the computing system to place the representation in a selected state (270). For example, as described with examples of FIG. 3A through 3F, a user can interact with a user interface to place the representation of each entity in the selected state.

The collection can then be displayed based on the selected filter parameter or parameters (associated with entities having representations in the selected state) (280). For example, filtered set of data items from the collection can be displayed in a particular region of a computing device.

### Examples

FIG. 3A through FIG. 3F illustrate various example interfaces for displaying data items from a collection based on a selected entity or set of entities. Examples of FIG. 3A through FIG. 3F are provided in the context of a computing device that renders a presentation in which a filtering mechanism such as described with examples of FIG. 1 and FIG. 2A are provided. For example, a tablet 300 can operate a browser to access a site, from which a presentation 310 (e.g., webpage) that enables display of data items 312 (e.g., images), and further filtering of data items based on contacts. As another example, the tablet 300 can operate an application that accesses data items stored on the device. The application can include functionality for enabling display and filtering of data items. Still further, the tablet 300 can operate an application that accesses a network service to receive data items and/or functionality corresponding to the filtering mechanism as described by various examples.

With reference to FIG. 3A, tablet 300 can display the presentation 310 in accordance with examples described herein. The presentation 310 can include a set 318 of individual data items 312. In FIG. 3A, the depicted set 318 can be associated with a corresponding entity 311. The entity 311 can correspond to a contact, buddy or friend of the user. The entity or user, may for example, label the set of images, or otherwise provided a theme for the set. In an example, the entity 311 can be represented by a name 313 and an avatar 315. The set 318 can include multiple images, which may or may not be viewable at one time on the presentation.

In FIG. 3B, the presentation 310 can be supplemented with a panel 320 that identifies multiple entities by graphic representation. In particular the panel 320 includes multiple avatars 318, each of which represents a corresponding entity. The user can interact with the panel 320 to place the avatars 328 representing individual entities in a selected state. A filter setting 322 can identify those entities which have been selected, by, for example, placement of the corresponding avatar 328 in a selected state. Each avatar 328 that is placed in a selected state can plus correspond to entity that has been selected for purpose of viewing data items of that entity in the filtered state (e.g., to be exclusion of data items of non-selected entities).

In an example of FIG. 3B, a filter parameter 322 can identify those entities that have been selected for purpose of filtering data items. Various entities can be graphically represented by avatars 328 and displayed in a separate user interface feature, provided as a panel 320. The filter parameter 322 can be determined from the entities 328 that are displayed in the panel 320. In an example of FIG. 3B, the filter parameter 322 is shown to have a null selection state, corresponding to no filters being place. Thus, data items of “all members” are depicted as part of the presentation 310. For example, the filter setting 322 can identify those entities which have avatars 328 placed in the selected state. The presentation 310 depicts those data items 312 associated with the selected entities. When the null state is selected, no filtering is performed with regard to entity designation. Thus, data items are depicted without regard to selection for anyone user.

FIG. 3C illustrates an instance where a user selects a single entity by placement of the corresponding avatar 328 as provided in panel 320 into the selected state. For example, the user can use a mouse to select a specific avatar 328, or alternatively, touch the display of tablet 300. The filter parameter 322 can be updated to reflect which entity is in the selected state. The presentation 310 can display only those data items 312 associated with the selected entity. Alternatively, the display region can prioritize, cluster or otherwise sort data items based on the selected filter parameters.

In one implementation, the user can deselect a selected entity by tapping or otherwise re-selecting the avatar 328 in the panel 320 that is in the selected state. Additionally, the user can add multiple entities to a filter. For example the user can place multiple avatars 328 in the selected state.

FIG. 3D illustrate a specific example for selecting multiple entities when filtering data items. In an example provided, the user can perform an action corresponding to pushing an avatar 328 from the panel 320 vertically as a mechanism for providing input that designates that entity as being in a selected state. When multiple entities are selected, the avatar of one selected entity can be moved vertically downwards to de-select that entity. The filter parameter 322 can display the current filter state, specifically the number of entities which comprise the filter. The presentation 310 can display data items from some or all of the selected entities.

In variations, an all-select and de-select feature can be utilized. The user can provide input to select all or deselect all entities for purpose of filtering (or on filtering) data items displayed in the presentation 310.

FIG. 3E and FIG. 3F illustrate an example in which multiple entities are selected to filter the content items. In FIG. 3F, the user can activate a menu 330 or scroll down list that illustrates avatars 328 and/or other identifies for each selected entity. The user can optionally scroll the menu in order to deselect individual entities. Alternatively, entities can be selected through use of the menu 330.

With further reference to FIG. 3A through FIG. 3F, data items can be clustered in the presentation 310 based on entity selection (e.g., made through selection of avatar 328 in panel 320). In one implementation, each cluster can correspond to particular entity. Furthermore, a number 336 or other quantitative designation can designate a number of data items in the particular cluster.

Hardware Diagram

FIG. 4 is a block diagram that illustrates a computer system upon which embodiments described herein may be implemented. For example, in the context of FIG. 1, system 100 may be implemented using a computing system such as described by FIG. 4.

In an embodiment, computer system 400 includes processor 404, memory 406 (including non-transitory memory), storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420 (wireless or wireline).

In one example, the storage device 410 can store a collection of data records 411. Additionally, the storage device 410 can store information 417 that identifies entities, and which provides or identifies filtering parameters based on the individual entities. The memory 406 can store instructions 413 for filtering the data collection by entity. In addition, the memory 406 can store filtering instructions 413 that provide for the display of avatars or other graphic representations of entities. The processor 404 can execute the instructions in order to enable users to select entities by placing the graphic representations in the selected state, and further for filtering the collection of records for display based on which entities are selected.

Computer system 400 can include display 412, such as a cathode ray tube (CRT), a LCD monitor, and a television set, for displaying information to a user. An input device 414 is coupled to computer system 400 for communicating information and command selections to processor 404. The input device 415 can correspond to, for example, a touch-screen or touch sensitive sensor. Other examples of input device 414 include a mouse, a trackball, or cursor direction keys for communicating direction information and command selections to processor 404 and for controlling cursor movement on display 412. While only one input device 414 is depicted in FIG. 4, embodiments may include any number of input devices 414 coupled to computer system 400.

According to one aspect, examples such as described with FIG. 1 through FIG. 3F can be implemented using computer system 400, in response to, for example, processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform operations as described by various examples. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for providing data items from a collection, the method being implemented by one or more processors and comprising:
(a) associating each entity in a plurality of entities with a corresponding set of data items, the corresponding set of data items associated with each entity in the plurality entities being part of the collection;
(b) assigning a representation to each entity in the plurality of entities;
(c) enabling the representation of any one or more entities in the plurality of entities to be placed in a selected state;
(d) filtering the collection of data items to display data items from the set of data items of each entity for which the assigned representation is placed in the selected state.

2. The method of claim 1, wherein (a) includes associating each entity with a set of data items originated from or communicated by that entity.

3. The method of claim 1, wherein (c) includes providing a panel that includes the representation for each entity in the plurality of entities.

4. The method of claim 3, wherein (c) includes enabling a user to place any two or more representations in the selected state, and wherein selecting includes providing at least one data item from the set of data items of each entity for which the assigned representation is placed in the selected state.

5. The method of claim 3, wherein (b) includes providing an avatar representing a corresponding person.

6. The method of claim 1, wherein each data item of the collection corresponds to one of a file, a document, or a record.

7. The method of claim 1, wherein (d) includes displaying only data items from the set of data items in at least a portion of a display area for displaying data items from the collection.

8. The method of claim 3, further comprising enabling a user to slide or toggle from a first representation of one entity to a second representation of another entity in order to place either or both of the first representation or the second representation in the selected state.

9. A system comprising:
a memory that stores a collection of data items;
a processor to:
associate each entity in a plurality of entities with a filter parameter;
provide a representation of each entity in the plurality of entities;
enable a user to place the representation of any one or more entities in a selected state; and
filter the collection based on a filter parameter associated with the entity represented by each representation that is placed in the selected state.

10. The system of claim 9, wherein the processor associates each entity in the plurality of entities with the filter parameter based on a corresponding set of data items that comprise a portion of the collection and which originate from or are communicated by that entity.

11. The system of claim 10, wherein the processor filters the collection by providing, for display, only data items from the corresponding set of data items that are associated with the one or more entities that have their representation placed in the selected state.

12. The system of claim 9, wherein the processor displays the representation as an avatar.

13. The system of claim 9, wherein each data item of the collection corresponds to one of a file, a document, or a record.

14. A computing device comprising:
a memory that stores a collection of data items;
a processor to:
associate each entity in a plurality of entities with a corresponding set of data items, the corresponding set of data items associated with each entity in the plurality entities being part of the collection;
assign a representation to each entity in the plurality of entities;
enable the representation of any one or more entities in the plurality of entities to be placed in a selected state; and
select, for display in at least a portion of a display area for displaying items from the collection of items, only data items from the set of data items of each entity in the plurality of entities for which the assigned representation is placed in the selected state.

15. The computing device of claim 14, wherein each data item of the collection corresponds to one of a file, a document, or a record.
